(19) United States
(12) Patent Application Publication
(10) Pub. No.: US 2023/0415941 A1
(43) Pub. Date: Dec. 28, 2023

(54) SYSTEM AND METHOD FOR OPERATING A SYSTEM FOR TREATING CONTAINERS

(71) Applicant: KRONES AG, Neutraubling (DE)

(72) Inventors: Ottmar AMANN, Hohenfels (DE); Stefan WENZL, Regensburg (DE); Stephan JAEGER, Krailling (DE); Marcel STRICKROTH, Regensburg (DE); Katarina MEHRINGER, Regensburg (DE); Sandra BREITSCHAEDEL, Regensburg (DE); Gerald HUETTNER, Vilseck (DE)

(21) Appl. No.: 18/039,182

(22) PCT Filed: Nov. 15, 2021
(86) PCT No.: PCT/EP2021/081749

§ 371 Date: May 26, 2023

(30) Foreign Application Priority Data
Nov. 26, 2020 (DE) 10 2020 131 365.9

(51) Int. Cl. B65B 57/00; B67C 3/00; B29C 49/78

(52) U.S. Cl. CPC B65B 57/00; B67C 3/007; B29C 49/786; B29C 2049/7861; B29C 2795/002; B29K 2067/003

(57) ABSTRACT

Disclosed to a method for operating a system for treating a plurality of containers, with the steps: providing at least one container which has an ID, by which the container can be uniquely identified, wherein an identifier can be assigned to the ID, which identifier is stored in a memory device which is connected or can be connected to the system at least temporarily via a public network in order to communicate data; treating the container with a treatment apparatus of the system, collecting at least one data value with respect to the container and/or with respect to at least one treatment step of the container; and providing the at least one data value for transmission and/or storage in the memory device.

The present invention relates to a system and a method for operating a system for treating containers, and a system for treating containers. Systems for treating containers and methods for operating them have been known from prior art for some time. In this regard, the present invention relates to containers and in particular to plastic containers. The containers may be containers from the beverage and/or food and/or cosmetics industries. For example, it may be bottles, such as glass bottles and plastic bottles. Particularly preferred are reusable containers which, for example, are returned to the product cycle after use by a consumer and are cleaned and/or recycled for this purpose.

In particular, the present invention relates to container serialization, such as bottle serialization. In the case of bottle serialization, the individual bottles in particular are marked—in particular unambiguously—for example by affixing a unique marking, and can thus be distinguished from one another individually, in pairs (in each case).

In the area of serialization of bottles, there are various approaches in the prior art, for example, unique IDs (identifiers) can be applied via the label. However, this form of serialization is not suitable for all intended use cases. For some of these use cases, the time of application of the ID would be too late, since, for example, in the case of a plastic container, labeling usually takes place after the filling process and definitely only after the heating and blowing process.

From the systems and the methods for operating these, which are currently known from the prior art, one of the disadvantages is that previous solutions for container serialization intervene too late in the process chain and thus cannot be integrated into the envisaged use cases. Furthermore, the disadvantage arises that measured values collected at an early stage of the process during bottle production cannot be individually assigned to each bottle. For example, the preforms (plastic preforms) are usually not yet clearly marked.

The object of the present invention is to overcome the disadvantages known from the prior art and to provide a system for treating containers and a method for operating the system in which possible all information and measurement data, as well as process and product data, are accessible for each process stages as possible.

According to the invention, the object is solved by the subject matters of the independent claims. Advantageous embodiments and further embodiments of the invention are the subject matter of the sub claims.

In a method according to the invention for operating a system for treating a plurality of containers, in particular bottles, preferably plastic containers, at least one container (and preferably a plurality of containers) is provided which (preferably in each case) has an identification means, in particular machine-readable means, by means of which the container can be uniquely identified. The container is preferably a beverage container or a container from the food or cosmetics industry. This can be a plastic preform or a fully formed container such as a bottle. In particular, the method relates to a treatment of containers in a manner that allows the traceability and/or retraceability of a treatment.

In this context, the (respective) identification means can be assigned (and/or allocated) an identifier—in particular unambiguously—which is stored and/or can be stored in a memory device, in particular a cloud-based memory device. Preferably, the memory device is connected or connectable to the system at least temporarily via a public network—such as via the Internet—for data communication.

Furthermore, the container (preferably the plurality of containers) is treated with at least one treatment apparatus of the system. It is conceivable that the system has only one treatment apparatus. Preferably, however, the system has at least two, and more preferably a plurality of (different) treatment apparatuses. Preferably, the plurality of containers (in particular one after the other and/or individually)—preferably arranged in a container stream—passes through in particular all these treatment apparatus and is in particular treated by them.

The container is preferably transported at least temporarily in the (preferably entire) treatment apparatus (preferably at least in portions in the and particularly preferably in the entire system) with at least one transport device along a predetermined transport path in a transport direction. The transport device preferably transports the container (in each case) into or out of the treatment apparatus during its treatment and/or during the container feed and/or discharge.

Furthermore, (in particular in the treatment apparatus)—preferably for each container—at least one data value is collected with respect to the container (preferably in each case with respect to the respective container of the plurality of containers) and/or with respect to at least one treatment step of the (in particular respective) container (in particular performed by the treatment apparatus).

Furthermore, at least one data value is provided—in particular by the treatment apparatus—(in particular in each case or for each container) for transmission and/or storage in the memory device.

Preferably, (in particular in each case) an assignment is produced and/or can be produced between the data value (or, in particular, data characteristic thereof) and the respective identifier of the container. This assignment is preferably stored in the memory device in a retrievable manner (in particular permanently) and can therefore be retrieved from the memory device at (any) later time.

By the expression of a data communication connection (i.e., connection for data communication) between the memory device and the system and, in particular, the treatment apparatus via a public network, it is to be understood in particular that the data communication takes place—at least temporarily—at least in portions (preferably completely) via the public network (such as the Internet). In particular, the memory device (at least partially and preferably the entire memory device) is connected at least temporarily and/or at least in portions to the system (and in particular to the treatment apparatus) via at least in portions wireless and/or at least in portions wired (preferably completely wired) communication connections or communication lines.

Preferably, at least part of the memory device, and preferably the entire memory device, is not connected to the system, and in particular to the treatment apparatus, exclusively via a private network, such as an internal company network. In other words, the memory device cannot be accessed exclusively via the private network or the internal company network (in which the system is integrated). Preferably, a data communication connection between the system and the memory device always has a communication portion, which in particular is to be exclusively via a public network (such as the Internet).

However, it is also possible that the memory device is integrated in its entirety into an internal company (communications) network. Preferably, in this case, at least a part of the data stored thereon can be accessed via a public network.

Treating the container means in particular production, further treatment and/or further processing of the container. A production of the container can be, for example, a blow molding process of a plastic preform into a (molded) plastic container such as a plastic bottle, but also an injection molding process of a plastic preform. Further treatment of the container can be, for example, sealing, cleaning, sterilizing, inspecting, in particular also transporting, labeling, filling with a product such as a beverage, printing and/or packaging. Further processing of the container is to be understood in particular as treating the container after it has been delivered to an (intermediate) dealer, such as transporting it to the latter, selling it to the end customer, a recycling process, a cleaning process of the (already used) container.

The treatment step may be a performed treatment step and/or a treatment step to be performed (by the treatment apparatus).

In other words, the present invention proposes that, in the case of containers to be treated which have (in particular permanently) an—in particular unambiguous—identification means and are thus present in an individualized state, data values which are collected during a treatment of these containers are stored in a memory device in which an information or a value (namely the identifier) which is characteristic of the identification means and/or can be assigned unambiguously in particular is also stored or is (still) stored.

Preferably, (at least) one cloud (as memory device) or (at least) one cloud-based memory device is provided, in which both at least one identifier and preferably a plurality of identifiers of the individual (preferably all) containers, as well as the respective data value collected (preferably for all treated containers) and particularly preferably all data values collected for the container and particularly preferably for all containers are stored.

It is therefore proposed in particular to provide and/or supplement and/or update (at least) one database (stored on the memory device) in which a plurality of identifiers (or data characteristic thereof) are stored, each of which can preferably be unambiguously assigned to an already individualized container and/or a container still to be individualized. Furthermore, a plurality of data values is preferably stored in the database, which have been collected by at least one treatment apparatus and preferably by a plurality of treatment apparatuses and which can each be assigned (exactly) to one container and particularly preferably to an identification means and/or identifier. Preferably, the database is set up in such a way that an assignment of (in particular determined and preferably all) data values, which have been collected for a given container, to the associated identifier, which is also stored in the database, is possible and can be retrieved.

The collection of a data value is understood to mean in particular the detection of a measured value, which is performed for example by a measuring device such as a sensor, etc. (for example on the container), but also a recording and/or collection of a process variable or of a process parameter (for example stored in a memory device, for example of the treatment apparatus), on the basis of which the treatment apparatus performs a treatment (on the container to be treated). A data value can also be understood as a type of treatment, such as a product to be filled, or also a characteristic variable for the type of treatment apparatus and/or treatment organs. Furthermore, the data value may also be environmental parameters such as temperature, pressure, time, location in relation to the treatment apparatus and/or the treatment of the container.

The present invention offers the advantage that collected measured values can again be individually assigned to each bottle. In particular, all data values which are collected in relation to a container or a treatment thereof by a treatment apparatus and in particular by all treatment apparatuses can be specifically assigned to each container and the measured values (as well as the assignment) can be retrieved at a later time. Advantageously, each machine of a line or each treatment apparatus of a system shall be able to deposit data or data values to an identification means and/or an identifier (and thus to a container or a bottle).

The serialization of individual containers and in particular bottles within a production line and the associated absolute traceability open up a wide range of application areas. For example, each container and in particular each bottle can inform a detection device (such as checkmates), inspectors, or other reading units who it is via the serialization code or identification means, allowing some of the intelligence of the machine control system to migrate to the containers and in particular the bottles. This allows, for example, treatment parameters to be retrieved or provided by the treatment apparatus using the (unique) identification of the container.

Furthermore, the container itself provided with an identification means can be used to control the system and, in particular, the treatment apparatus and, particularly preferably, a plurality of treatment apparatuses. Accordingly, the principle of “bottle controls machine” can be converted, and a distinction can be (knowingly) made in the production line between different bottle types, product types and combinations thereof. Preferably, then, at least one data value stored on the memory device, and preferably a plurality of data values related to an identifier, and preferably related to a plurality of identifiers, may be used for intelligent machine control. In this context, reference is made to the disclosure document DE 10 2017 120 201 A1, the entire disclosure content of which with respect to a self-learning machine and in particular blowing machine, shall be deemed to be disclosed in this description.

For example, a system can have a line in which several different types of product can be produced simultaneously, since by means of the unique coding (in particular based on the identification means) of the container and in particular of the bottle and the information (in the database) deposited (preferably on the memory device) about it, it can be communicated in particular to the respective treatment apparatus or machine, for example a filler, that in the next cycle the container “XY” is in the feed and therefore the product “AB” must be fed into a predetermined filling valve (filling valve “XX”).

In a preferred method, an identifier generating device of the system provides the—in particular unambiguous—identifier and preferably a plurality of identifiers which are suitable and intended for a unique identification of a container. The identifier can be, for example, a numeric quantity or a combination of characters. Preferably, the identifier generating device has a processor device that generates a plurality of identifiers, particularly according to a predetermined method. In this regard, the identifier generating device may also have a comparison device that compares a generated identifier with a plurality of existing identifiers and/or identifiers stored in an ID pool and/or identifiers that can be retrieved, and checks whether this generated identifier has already been used and/or previously generated.

The identifier generating device is preferably a script or an independent program installed directly on an individualization device which is suitable and intended to provide a container with an identifier associated identification means, such as on an ID printing device. However, it is also conceivable that an external system exists on which such a script is running. Preferably, a single identifier and, preferably a plurality of identifiers can be retrieved by the system and, in particular, by the individualization device, for example, also in the context of a SaaS (“Software as a Service”) application. Preferably, there is at least temporarily a (communication) connection between the individualization device (as hardware) and the identifier generating device (the ID generator), which can be converted particularly as software or as a software service.

In principle, a single identifier generating device is required for each system, and likewise only a single identifier generating device is required for the plurality of container apparatuses that treat a given container (in and in particular also outside a system). It is possible, however, that several (coordinated) identifier devices are present which, however, also generate different identifiers in pairs.

It is possible, as described, that the IDs are generated by an ID generator (the identifier generating device), initiated for example by a request for a new ID. However, it is also possible that the IDs are not generated, but are retrieved from an ID pool. In both cases, the ID generator or identifier generating device is responsible for providing unique identifiers (IDs).

Preferably, the identifier generating device can retrieve an identifier—in particular a unique identifier—from an ID pool (in particular in electronically stored form) (which can also be stored on the (cloud-based) memory device) and, particularly preferably, can retrieve a plurality of identifiers and provide and/or transmit them to an individualization device, which provides a container with an identification means that can be uniquely assigned to the identifier. The ID pool preferably provides the identifier generating device with a collection (pool) of identifiers (IDs). Preferably, the IDs are subject to an algorithm and/or rules such that, for example, the production date can be deduced from the ID or the identifier by coding. Each ID is preferably unique.

In particular for the individualization of a container, an identification means is preferably assigned to (in particular each) an identifier—in particular uniquely—which is suitable and intended for individually and/or uniquely identifying a container provided and/or marked with the identification means.

It is conceivable that a one-to-one assignment is possible between each container having an identification means and (exactly) one identifier (generated and/or present in the ID pool and/or stored in the memory device). However, it is also conceivable that only a unique assignment of a container having an identification means with an identifier (generated and/or present in the ID pool and/or stored in the memory device) s possible. This means that, for example, several identifiers (even those not yet used) can be present in the ID pool or stored in the (in particular cloud-based) memory device.

The identification means may be, for example, a 2-D bar code, bar code, matrix codes (QR code, data matrix, MaxiCode, Aztec code, JAB code, Han-Xin code, etc.), an inductively powered wireless communication device which, preferably with inductive energy supply, is suitable and intended for the wireless transmission of data, in particular an RFID communication device (Radiofrequency identification) or RFID transponder and similar. The identification means can be machine-readable in an optical, electronic, magnetic and/or haptic or tactile manner by means of a detection device. Operating frequencies of 13.56 MHz (HF) or 860-960 MHz (UHF) as well as 125 kHz (LF) are known for wireless transmission of data.

Identification means that can be read quickly and particularly within 80 ms have proven to be particularly suitable. Preferably, the identification means, such as the RFID communication device, has a memory size of at least 50 bytes, preferably at least 100 bytes, and particularly preferably 144 bytes. Preferably, the identification means has a memory size of maximum 250 bytes, preferably maximum 144 bytes. Preferably, the identification means has a geometric extension of at least 1 mm, preferably at least 5 mm and particularly preferably at least 10 mm in one direction and/or a geometric extension of at least 1 mm, preferably at least 5 mm and particularly preferably at least 10 mm in a direction perpendicular thereto.

Preferably, the identification means has a geometric extension of maximum 50 mm, preferably at least 10 mm and particularly preferably at least 5 mm in one direction and/or a geometric extension of at least 50 mm, preferably at least 10 mm and particularly preferably at least 5 mm in a direction perpendicular thereto.

Preferably, matrix codes have a code size of more than 22×22 dots. Preferably, the identification means, and in particular the container which has the identification means, is suitable and intended for the identification means to remain permanently in or on the container and, as a result, the container preferably remains permanently in this individualized state after it has been individualized. In particular, after the initial individualization, the container has the identification means in all (subsequent) treatment apparatuses in which it is treated (particularly before its packaging and/or delivery to the customer). Particularly preferably, the container also has the identification means after sale to the end consumer. Preferably, the identification means is firmly (not non-destructively removable) arranged or inserted on the container. This also allows the container to be captured and identified at a point of sale and/or recycling location.

Preferably, the system, and in particular a production apparatus which is suitable and intended for the production of a container and/or plastic preform, has an individualization device which provides the container (for its—in particular unique—individualization) with the identification means or is suitable and intended for this purpose. A production apparatus may be, for example, a blow molding apparatus and/or an injection molding apparatus and/or an apparatus for the production of glass containers. Preferably, (by the individualization device) the identification means is arranged and/or attached and/or inserted on the container.

It is possible that the individualization device is arranged in the (treatment) line of the plurality of containers, preferably on the transport device of the treatment apparatus, and is preferably included in the (treatment) line and/or in the system. The individualization device can, for example, be arranged between two treatment apparatuses of the system, wherein a container to be individualized is transported from a transport device of one (first) treatment apparatus to the individualization device and is transferred from there to a second treatment apparatus by the same or a subsequent transport device. Preferably, all containers that are transported to the individualization device are transported to and/or transferred to the second treatment apparatus. Preferably, (substantially) only containers are transported and/or transferred to the individualization device from the first treatment apparatus.

However, the individualization device does not necessarily have to be located in the line. It is conceivable, for example, that an individualization device can be assigned to several, mutually different lines and/or at least two, mutually different systems for treating a mutually different plurality of containers. This offers the advantage that the individualization applies, for example, to both disposable and reusable PET containers, or also glass containers, cans and similar, or (only) one individualization device can be used for containers of different types, which are treated in systems different from each other. Preferably, the individualization device is integrated into at least one and at least two system (different from each other) in such a manner that it transports and/or transfers containers to be individualized from the at least two different treatment apparatuses (which are preferably part of two systems different from each other) (in particular via two transport devices which are different from one another at least in portions and preferably completely) and/or containers individualized by the at least two different treatment apparatuses (which are preferably part of two systems different from each other) (in particular via two transport devices which are different from one another at least in portions and preferably completely).

Preferably, the individualization device has a printing device and, in particular, a direct printing device (a so-called “ID printer”), which is preferably suitable and intended for directly and/or immediately processing and, in particular, printing on a container wall and/or the plastic preform.

Preferably, the individualization device has a laser, in particular a CO₂ laser, by means of which an identification means (such as a QR code) can be applied to a container (such as a plastic preform).

Preferably, the individualization device has an inkjet printer, such as an inkjet printer, by means of which an identification means (such as a (QR) code) can be applied to a container (such as a plastic preform).

It is also conceivable that the individualization device has a printing device for applying ink, in particular ink that fluoresces only or merely under UV light irradiation. This offers the advantage that the choice of such an identification means does not affect the external appearance of the container, which is visually perceptible by a consumer.

Preferably, the individualization is applied in the unstretched area of the preform, particularly preferably in the area up to 10 mm below the preform support ring.

In addition, the individualization device can also have tools which, during and/or immediately after an injection molding process, treat the surface of the container to be produced and/or introduce an individualization means (e.g., a transponder) into a container, such as a wall of the container to be produced, in particular in such a manner that the individualization means is surrounded by—in particular the same—material, in particular from all sides.

In a further preferred method, the containers are provided with the identification means during their production and/or temporally before and/or during a forming process from a plastic preform to the plastic container. Preferably, the plastic preforms are provided with the identification means temporally before the plastic preforms are heated (in a heating device or in an oven). This offers the advantage that serialization can be used in as many or all process steps as possible if the plastic preform or a preform in the oven already has a unique identification before heating. In particular, it is preferable (mandatory) to apply the information to the preform (in contrast to the prior art).

It is therefore proposed to use marking or individualization (via identification means) of plastic preforms or preforms already at a very early stage of the process in order to control parameters in the system and particularly in the treatment apparatus or in a plurality of treatment apparatuses depending on the information associated with the (assigned) identifier (or, for example, stored in the memory device and linked to the identifier) and/or to reassign collected measured values or data values individually to each container.

Typically, a plastic preform has an already fully formed area, such as a mouth area with an already formed thread or a support ring, and at least one area to be stretched (such as a main body of the plastic preform). The area to be stretched is typically expanded, in particular in the longitudinal direction, as part of a (stretch) blow molding process by application of a pressurized fluid medium and is preferably stretched against a blow molding device forming a cavity.

Preferably, a plastic preform (from the individualization device) is provided with an identification means, in particular on a portion of the plastic preform to be stretched. Preferably, therefore, the plastic preform is not provided with an identification means at a mouth area or at a support ring (although equally possible), but at the area of the main body, in particular at a side wall of the main body. Preferably, the identification means used is one that is also expanded during a forming process of the plastic preform into the plastic container. Preferably, the identification means is suitable and intended to be in a machine-readable state (also) after its spatial extension in at least one dimension and preferably in at least two dimensions.

Preferably, a QR code is used as the identification means (which is embossed into the wall of the plastic preform, for example, and preferably printed on to prevent areas of differing wall thickness from influencing the stability of the container). A so-called “inflatable QR code” offers the advantage that such a code can not only be used (as it were, or in the same way as a grid is applied) for detecting degrees of stretch in the blow molding machine or in a (stretching) blow molding apparatus, but also offers a way of individualizing the containers at an extremely early stage in the process, namely during the production of the plastic preforms.

Preferably, the system has a heating apparatus for plastic preforms for heating them before the plastic preforms are expanded into a plastic container in a blow molding machine (or a (stretch) blow molding apparatus).

Preferably, the treatment apparatus, in particular the heating apparatus, has a detection device suitable and intended to detect the identification means of the plastic preform. Preferably, at least one value, in particular a process variable, is derived on the basis of the detected identification means for the control of at least one treatment apparatus, in particular the heating apparatus.

This offers the advantage of using serialized containers in the preform heating process, in particular in heating apparatuses which are suitable and intended to heat each container individually and in particular two containers immediately following one another in different manners (e.g. so-called “flexwave” heating apparatuses). In this manner, the identification means can be detected and/or read out prior to entry into the heating apparatus (or oven) and, for example in the machine control, the heating pattern required for the respective plastic preform can be stored. This means that a wide variety of container sizes (preform sizes) can advantageously be set in motion and treated in one heating device (or in one oven). This advantageously enables the subsequent blow molding process (of the plastic preforms into the plastic containers) to be adapted in such a manner that different container shapes and/or container sizes can be produced at the same time. Such a control may, for example, have a parallel connection of two or more blow modules or blow molding apparatuses for forming plastic preforms into plastic containers, or a blow molding machine or blow molding apparatus with different cavities (or blow molding apparatuses).

In a further preferred method, the identification means is detected at least once and preferably several times, preferably by a detection device, in particular before the container is discharged from the treatment apparatus. Preferably, in each treatment apparatus of the system, the identification means is detected at least once and more preferably several times. For example, (in each case) to collect a data value, the identification means may be captured (and provided along with the data value for transmission to the memory device). Detecting the identification means of (each) the container at least once offers the advantage of knowing where the container is currently located.

Preferably, immediately after production of the container and/or after production of a plastic preform, the identification means is detected by a detection device, particularly preferably upstream of the heating device for plastic preforms. Preferably, at least one detection device for detecting the identification means is arranged between each treatment apparatus of (each of) two different treatment apparatuses (which are in particular arranged in their own housing). Preferably, the identification means of the container is detected before leaving the respective treatment apparatus and is transmitted in particular (together with at least one data value) to the at least one memory device.

Preferably, a control device which controls the treatment performed on the container, for example an inspection device, has a detection device which also detects the identification means of the container together with the measurement data.

In a further preferred method, the data value is selected from a group comprising various types of data values, such as information or (characteristic thereof) data relating to the container, to a measured value, to a treatment parameter, to a process data value, to a time stamp, to a production date of the container, to a production location, to a product for the container, to a filling time stamp of a product into the container, to a filling location of a product into the container, to the treatment apparatus (or at least one element of this treatment apparatus), to machine data, to an outer packaging, to the transport device, to a distribution modality, to a point of sale (PoS) and similar. Preferably, a plurality of data values of various types are collected and made available for transmission and, particularly preferably, transmitted to the memory device.

In a further preferred method, at least two data values and preferably a plurality of data values of different types are collected, which can be assigned to the same identification means and/or the same identifier and which are preferably collected by at least two and particularly preferably a plurality of different treatment apparatuses. Particularly preferably, (substantially) all of the collected data values are transmitted and/or made available for transmission to the memory device.

The present invention is further directed to a system for treating a plurality of containers, in particular bottles, preferably plastic containers, having at least one treatment apparatus which is suitable and intended to perform at least one treatment step on said containers.

Preferably, the system has at least one transport device which is suitable and intended to transport the containers at least temporarily in the treatment apparatus.

Thereby, the (preferably each) treatment apparatus has at least one data collection device which is suitable and intended for data collection of at least one data value with respect to the container and/or with respect to at least one treatment step. The data collection device may be, for example, a control device, in particular for controlling and monitoring as well as logging production data (such as a fill level, controlling the closure), control for quality assurance of the container and/or the filling process and/or closure and/or packaging process, a measuring device, an inspection device, a camera, a sensor device (in particular for the recording of process and/or environmental parameters) or also a thermometer and/or air pressure device.

The system preferably has at least one detection device for detecting an identification means of the containers, by means of which the containers can be uniquely identified.

According to the invention, the system has a communication device configured to at least temporarily establish a communication connection with at least one, particularly cloud-based, memory device. Preferably, the memory device is (at least in portions) at least temporarily connected or connectable to the system for data communication via a public network. According to the invention, an identifier that can be uniquely assigned to the identification means is stored and/or can be stored in the memory device. In this context, the treatment apparatus (and in particular a plurality of treatment apparatuses of the system in each case) is configured, suitable and intended to provide the at least one data value to the communication device for, in particular at least indirect and/or for direct, transmission to the memory device and/or preferably storage in the memory device.

Preferably, the system is suitable and determined for the production of an association between the data value (or data characteristic thereof) and the respective identifier.

Thus, it is also proposed in the context of the system according to the invention that the data values collected from one and preferably from a plurality of treatment apparatuses are to be stored and/or stored on a memory device which is, for example, cloud-based and/or at least regionally located outside a company-internal network. The data values are in each case stored in a form that allow an assignment or assignability to an identifier (of the associated container). Preferably, at least one memory device is not directly integrated into an internal company network, at least in some areas. Preferably, at least one area of the memory device cannot be accessed exclusively via an internal company network, but a communication connection is possible exclusively (at least in some areas) via a public network such as the Internet. Preferably, this is an external memory device, which is located outside the (respective) treatment apparatus and particularly preferably outside the system.

In this regard, the system may be equipped with all of the features described above with respect to the method of operating a system, either individually or in combination. The system is preferably arranged, suitable and/or intended to perform the above-described method for operating a system (in particular also in accordance with any embodiment described as preferred) as well as all method steps already described above in connection with the method, individually or in combination with one another. Conversely, the method may be provided with any of the features described within the system, individually or in combination with one another.

With the use of (at least) a cloud-based memory device, a memory device is proposed which preferably has a plurality of servers (in communication connection with one another). This offers the advantage that the memory device is scalable, in particular due to the elasticity of a cloud, and a storage capacity can thus be expanded in a comparatively simple manner. Large capacities could be drawn upon if needed. This is in particular advantageous if as many as possible, and in particular substantially all, treatment apparatuses which treat a container, and particularly preferably all the containers of a system and/or a producer, during production and/or (further) treating and/or further processing, collect by means of a data collection device in particular a plurality of data values and these are made available for transmission to the memory device (and the data values deposited there and assigned to an identifier are to remain retrievable substantially permanently (in particular at least during the entire service life of the container).

The system preferably has at least two and preferably a plurality of in particular different treatment apparatuses which treat the same container (which is uniquely identifiable by means of the identifier means) and which are located at different locations spaced from one another and in particular not on the same company premises. Preferably, each of these treatment apparatuses can access the at least one (common) memory device and, in particular, store and/or query data values in a (in particular cloud) database stored thereon.

Preferably, the system has two memory devices, in particular each cloud-based. Preferably, these two memory devices are independent of one another. Preferably, these two memory devices differ in an access authorization, in particular for external third parties, and/or the type of data values which are stored. Preferably, the system and/or a treatment apparatus has at least one separate communication device for each of these storage devices, wherein the communication device has at least in portions a data transmission based on a protocol different from one another and/or an encryption system different from one another (for different weak or strong data encryption).

Preferably, a memory device, in particular cloud-based, is provided for system operator-side data are stored and/or to be stored on it, which in particular is not to be shared with third parties. Preferably, only the system operator has access to this memory device, but third parties are not allowed to access this memory device. Preferably, the system operator-side data can be data which are characteristic for a line and/or the system and/or an operation of the system and/or individual components thereof. For example, some and preferably all relevant data for the control and/or operation of the system may be stored in this memory device.

Preferably, the second, in particular cloud-based, memory device is configured in such a manner, in particular as a so-called general memory device, that, in contrast to the system operator-side memory device described in the previous paragraph, third parties can also access the so-called general memory device. Preferably, only a part of the data of the system operator's memory device is stored in this memory device. Preferably, for example, only elementary data such as when produced, what content and similar (product and/or container-specific information) is stored on this. Preferably, this data is transmitted from the system operator-side memory device to this (second or so-called general) memory device. Preferably, no (in particular system operator-internal) data for control and/or operation of the system is stored on the second or general memory device.

Providing these two clouds or these two cloud-based memory devices offers the advantage that each party involved can only see or retrieve the data that is necessary.

It could be that the first cloud-based memory device is a purely in-house (and/or system operator-internal) memory device configured in such a manner that only the system operator of, for example, a container manufacturing device and/or a system manufacturer has access authorization. The second cloud-based memory device could be configured in such a manner that an external third party, such as an end user and/or a retailer, also has access authorization to at least areas of the memory device.

In addition or as an alternative, it could also be that data values are (exclusively) stored on the first memory device which are, for example, process data, for example with respect to at least one treatment apparatus and preferably with respect to a plurality of treatment apparatuses which treat the container prior to delivery of the container and/or the container filled with a product. Preferably, data values relating to the type and/or size of the container and/or filling material, but preferably not process data for the production of the container, are stored in the second memory device.

Preferably, the treatment apparatus, and particularly preferably a plurality of treatment apparatuses, has (in each case) a communication interface via which a communication connection, in particular a real-time and/or direct communication connection, can be established at least temporarily with the memory device and in particular with the two (cloud-based) memory devices via the communication device.

The communication device is in particular a wired and/or wireless network.

In an advantageous embodiment, the treatment apparatus and preferably each treatment apparatus has a machine control device or machine control (SPS) and/or a human-machine interface (HMI). Preferably, communication between each treatment apparatus and the memory device takes place (in particular indirectly) via a data transmission device, which in particular collects the data values of several treatment apparatuses to be transmitted to the memory device and preferably only then transmits the data values to the memory device. Preferably, the system has only one data transmission device. Preferably, (in each case) a machine control device of a first treatment apparatus is (exclusively) connected to that of the next treatment apparatus, as seen in the transport direction of the container, for data communication and for providing and/or transmitting the collected data values to the memory device.

Preferably, a detection device for detecting the identification means of a container is arranged upstream (in particular directly) before the data transmission device, as viewed in the direction of transport.

Preferably, this detection device and the data transmission device exchange data related to data values to be transmitted to the memory device and/or related to a detected identification means.

In an advantageous embodiment, a data transmission device is provided which transmits the data values of at least two treatment apparatuses to be transmitted to the memory device, in particular simultaneously, to the memory device and, in particular, collects the data values to be transmitted for this purpose beforehand and/or stores them temporarily in a memory device.

Preferably, the communication device is suitable and intended for real-time processing and/or transmission of the data values provided by (in particular each of) the treatment apparatus.

In an advantageous embodiment, the communication device has (at least and in particular precisely) one integration layer, wherein a communication connection between the (communication interface of the) treatment apparatus (and preferably between each communication interface of the plurality of treatment apparatuses) and memory storage device and preferably the two memory devices, in particular for transmitting (for storing) and/or retrieving data values, can be established exclusively via the integration layer.

Preferably, the integration layer is an intermediate layer of an architecture of a software system of the system (which is structured in particular according to a layer architecture), in which the (software component of the) communication device is structured (at least in portions and preferably completely).

Preferably, a first intermediate layer (of a software system of the system and/or the communication device) may already be necessary due to the treatment machine or treatment apparatus. For example, in the case of a filling machine (as a treatment machine or treatment apparatus), a code reader can be installed in the machine outlet, which registers the incoming bottle and is preferably informed at this point by the filling machine as to which filling organ, capping organ, product the bottle was treated with. This offers the advantage that, for example, a filling machine with 120 filling valves does not require the same number of identification elements, i.e. 120 in this case. The same applies to a capper as a treatment apparatus.

This identification device (code reader), such as this one, e.g. 2-D code reader, can be arranged upstream of the treatment machine or treatment apparatus or downstream of it. Aggregating the data will work as long as the container position is assignable, i.e. also in the single lane area on the conveyor, wherein preferably aggregating is within a fixed assignable position (star pocket). In the case of a sensor arrangement in the inlet, the machine control knows which treatment organs will treat the container, and in the outlet, the control knows which organ has treated the container.

Preferably, a (or the) software system of the system and in particular of the treatment apparatus is configured and/or structured (in particular within the framework of a layered architecture) in such a way that it has at least one (first) intermediate layer. Preferably, this first intermediate layer is associated with the (or at least one) treatment apparatus. Preferably, the treatment apparatus can exchange data internally, i.e. within the treatment apparatus, via this (first) intermediate layer. In particular, a data detection device of the treatment apparatus (in particular also exclusively, without data exchange with a cloud-based memory device) can transmit data via the intermediate layer to a data processing device of the treatment apparatus that is different from the data detection device, such as the individualization device. This (first) intermediate layer can be the integration layer (mentioned above). Preferably, therefore, the (and particularly preferably any) treatment apparatus of the system can (also) use the integration layer for (also purely) internal data exchange.

Preferably, the communication device has a (in particular wired) (communication) bus, via which data can be transmitted. Preferably, the treatment apparatus and in particular each treatment apparatus communicates with the memory device via the communication bus.

In other words, the and in particular each treatment apparatus addresses the (communication) bus for communication with the memory device.

Preferably, the individualization device is suitable and intended to request and receive an identifier for a container to be provided with an identifier means via an application, in particular an ID generator application, which communicates with the communication bus to provide an—in particular unambiguous—identifier. Preferably, the communication bus communicates, in particular directly, with an identifier generating device and/or (in particular indirectly) with an ID pool, for querying and/or providing an identifier.

Preferably, the identifier generating device and/or an ID pool accesses resources, such as a processing power or a memory space) of at least one memory device, in particular for or during the generation and/or retrieval of an identifier.

Alternatively or additionally, however, the identifier generating device and/or the ID pool may have a memory device and/or processor of its own and independent of the, in particular cloud-based, memory device, which are used to generate and/or query an identifier. Preferably, such identifier generating device may be located in-house and in particular in the same building as at least a part and preferably the entire system.

Preferably, the treatment apparatus is adapted and intended to request data values from the at least one (and preferably also from the second) memory device via the communication device, in particular with respect to a predetermined container (to be treated) (which is preferably identifiable by means of the identification means), and/or to transmit data values for storing said data values. In particular, a treatment apparatus, and preferably each treatment apparatus, can make a status request with respect to a container to be treated.

Preferably, the treatment apparatus, and in particular each treatment apparatus, is suitable and intended to receive data relating to a container to be treated, which are transmitted by the communication device from the memory device, preferably to store them in an internal memory of the treatment apparatus, and particularly preferably to make a change to at least one setting and/or size and/or at least one process parameter (in particular relating to the, in particular individualized, treatment of the container to be treated).

It is conceivable that the identification means can be read out via a terminal, in particular a mobile terminal, such as a smartphone, tablet, laptop or similar, and data values stored in the memory device in relation to this container and in particular in relation to the identifier assigned to this container can be queried by means of the terminal. This can advantageously be used to allow an end consumer to ascertain, for example, the product source and/or manufacturing location and/or filling location and/or a distribution channel.

In an advantageous embodiment, the treatment apparatus is selected from a group comprising a heating apparatus for heating a preform, a forming apparatus for forming a plastic preform into a plastic bottle, a sterilization apparatus for sterilizing a container, in particular a plastic preform, a production apparatus for producing a glass bottle, a filling apparatus for filling a container with product, an inspection device for inspecting a plastic preform or a bottle, a labeling apparatus for labeling a container, a closing apparatus for closing a container, in particular a filled container, a control device, a packaging apparatus, a direct printing device for printing on a container, an assembling apparatus for assembling a plurality of containers into an assembly, a destroying apparatus for destroying the container, and similar.

In an advantageous embodiment, the system has at least one further treatment apparatus and preferably a plurality of further treatment apparatuses.

In an advantageous embodiment, the treatment apparatus is a further processing apparatus which is suitable and intended for treating a container after it has been delivered (in particular in an already filled state). For example, it could be a treatment apparatus (such as a transport apparatus) at the point of sale or a recycling apparatus.

The present invention is further directed to a system comprising a system in accordance with any of the embodiments described above and the at least one Internet-accessible and/or cloud-based memory device described above in the context of the system. In this context, the system and the memory device may each be equipped with all the features described above in connection with the method or the system, either individually or in combination.

Preferably, a processor is provided with the aid of which the data values stored in the memory device can be evaluated and in particular an analysis and/or actualization and/or an update of the database can be performed. For example, at least one additional data value associated with this identifier can be added to a given identifier.

Preferably, the processor of the memory device is suitable and intended to perform authorization and/or authentication of a client (such as a mobile terminal or treatment apparatus) with respect to a data transfer between the client and the memory device, such as a request for a data value and/or a transfer of a data value (with respect to a predetermined identifier).

The present invention is further directed to a method for, in particular, uniquely tracing and/or tracking and/or identifying a plastic container, which comprises producing the plastic container from a plastic preform. Preferably, the plastic preform is expanded into the plastic container (within a blow molding device) by the application of a fluid medium (such as blow air and/or a liquid such as the product to be filled).

According to the invention, this method comprises a step in which the plastic preform is individualized by means of arranging and/or introducing and/or producing an identification means, wherein the identification means is expanded at least in areas during the expansion of the plastic preform to the plastic container and/or changes at least one geometric extension in at least one direction and particularly preferably in at least two directions and in particular increases. Preferably, the identification means is a (in particular printed) QR code.

Preferably, exactly one identifier is assigned to this identification means. However, it is also conceivable that, conversely, the individualization of the plastic preform is performed by means of the identification means on the basis of a generated identifier.

Preferably, a container manufactured in this manner is used to provide at least one data value relating to the container and/or to its identification means and/or the associated identifier. In this regard, the method may be equipped with all the steps and features described above in connection with the operation of the system.

The present invention of a system and the method of operating a system has been described in relation to treating containers and bottles. However, the present invention is transferable to systems having treatment apparatuses for treating consumable products. The applicant reserves the right to make a claim for such a system and a method of operating such a system.

Further advantages and embodiments can be seen in the accompanying drawings:

In the drawings:

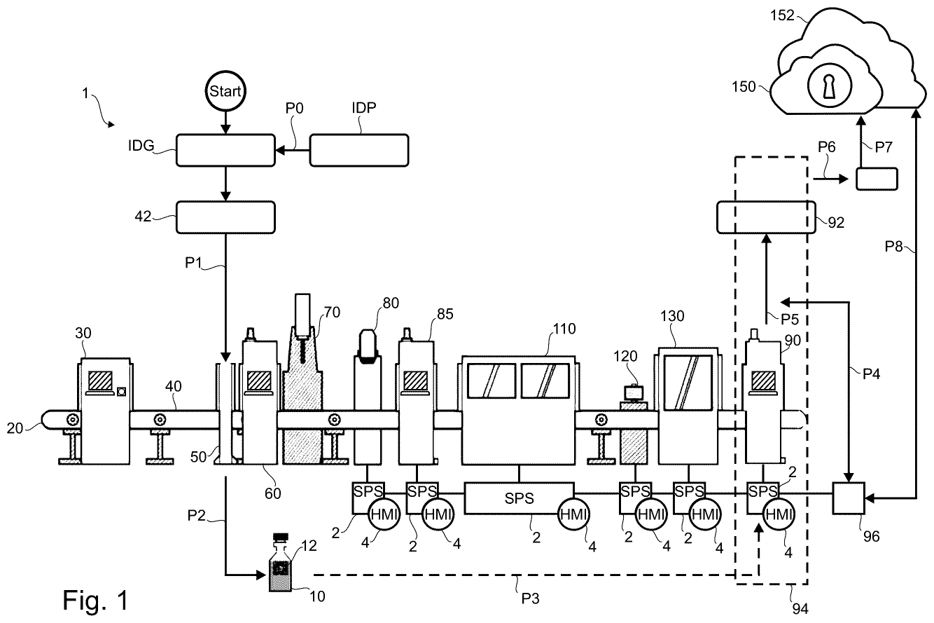

FIG. 1 shows a schematic diagram of a system according to the invention for treating containers in accordance with a first embodiment; and

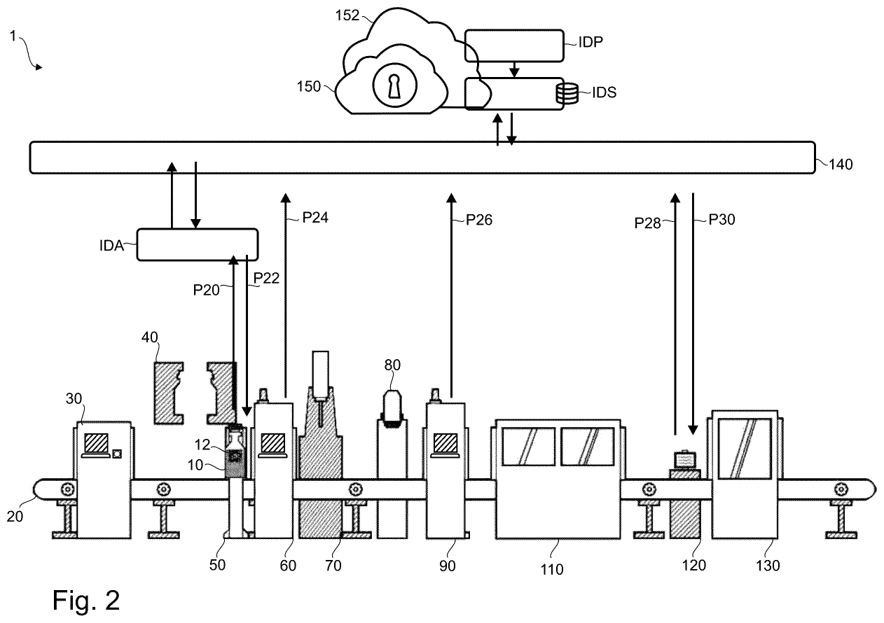

FIG. 2 shows a schematic diagram of a system according to the invention for treating containers in accordance with a second embodiment.

FIG. 1 shows a schematic diagram of a system 1 according to the invention for treating containers 10 in accordance with a first embodiment and describes the technical procedure for individualizing a container by marking this container, in this case a bottle.

The reference sign IDG indicates an ID generator, which is an identifier generating device responsible for providing unique identifiers (IDs). A variety of methods and solutions exist for generating (and also applying) identifiers or IDs.

The ID generator IDG is (here) a script that is installed directly on the individualization device, here designed as a printing device 50, the ID printer unit, or runs on an external system. There must be at least one (communication) connection between the ID printer unit or the individualization device as hardware and the identifier generating device, in this case the ID generator IDG, as software or software service.

The reference sign IDP indicate an ID pool (or identifier pool), which here provides the ID generator (generally the identifier generating device) with a collection (pool) of identifiers (IDs) (indicated by arrow P0). The IDs are subject to an algorithm and rules, so that by coding from the ID to, for example, the production date can be concluded. Each ID is unique.

The generation of IDs is indicated in FIG. 1 by reference sign 42. After generation, the ID is communicated here to the individualization device, in this case the ID printer unit 50, via an interface. The arrow P1 indicates the method step in which the ID (or an identification means assigned to this identifier) is applied to the container, in this case a bottle. The individualization device, in this case the ID printer unit, is responsible for applying the ID (or an identification means assigned to this identifier) to the bottle. The reference sign 12 indicates an identification means which is arranged on the bottle 12. This is, for example, a (printed) QR code.

In the embodiment shown in FIG. 1, a plastic preform is provided and fed from the transport device 20 to a heating apparatus 30 (so-called “preform heater”), heated therein and subsequently expanded in a blow molding apparatus, the arrangement of which within the system 1 is indicated by the reference sign 40, to form a (plastic) bottle 10. This bottle 10 is provided with an identification means 12 by the individualization device, in this case the printing device 50 (indicated by the arrow P2), resulting in a bottle having an identification means 12.

The bottle 10 begins its journey through the line (of the system 1). For this purpose, the bottle 10 can be transported by at least one transport device from a treatment apparatus to the next, as well as within the treatment apparatus(es). Shown here as treatment apparatuses (in a sequence downstream of the direction of transport of the bottle) are an inspection apparatus 60, a filling apparatus 70 for filling the bottle 10 with a product, a closing apparatus 80, a drying apparatus 110, a labeling apparatus 120, and a packaging device 130 for packaging the bottle 10.

In each case, the reference sign 2 indicates a SPS (machine control) of a treatment apparatus and the reference sign 4 indicates a human-machine interface (so-called “HMI”, Human Machine Interface).

The reference signs 85, 90 each indicate a control device (for example, at the end of the line and arranged between the closing device 80 and the drying device 110) which checks, for example, a fill level in the bottle and/or a proper arrangement of the closure on the bottle 10 and/or a retaining ring and/or proper labeling and/or packaging of the bottle 10 or further production data. These control devices 90 (here a so-called “checkmat”) in a line or in a system 1 serve as milestones and preferably read the IDs or record the identification means of the containers. This way, it is known where the bottle is currently located.

In addition, each machine or treatment apparatus 60, 70, 80, 85, 110, 120, 130, 90 of the system 1 shall be able to deposit data on an ID or identification means of a bottle.

In one embodiment, a data transmission device 96, the so-called “ready kit” is responsible for aggregating the data (which are collected in particular from several treatment apparatuses, e.g., checkmat 85, 90, a closing device 80 (“capper”) and/or a drying device 110 (“dryer”) and/or a labeling device 120 (“labeler”) and/or a packaging device 130 (“packager”). Therefore, the collected data of a system 1 in this embodiment is available in the data transmission device (here in the ready kit) at the earliest. The data transmission device 96 (the ready kit) relays the data to a cloud 150. In this embodiment, a detection device 94 for identifying a bottle (“bottle identifier”) is preferably provided, which preferably detects the identification means 12 or reads the ID thereby (characterized by reference sign 92, arrow P5). In this embodiment, the detection device can establish a (communication) connection to the data transmission device 96 (see arrow P4), via which the data aggregated by the data transmission device 96 can be transmitted to the detection device, which in turn, in the embodiment shown here, can assign this data to an identifier via the detected identification means 12 and writes the data together with the associated identifier or a quantity characteristic thereof here to a cloud 150 as a memory device (illustrated by arrows P6 and P7).

It is possible that two memory devices 150 and 152, which are in particular (at least partially and preferably completely) separate from one another, are present, which can each be provided, for example, as a cloud. There may be a data communication connection between these two clouds. For example, one of the two memory devices may be an in-house memory device, while preferably one of the memory devices is accessible (only) via a public network (at least partially outside the in-house network).

The two (particularly cloud-based) memory devices 150 and 152 may be externally closed systems. Preferably, a data communication connection for exchanging data and/or messages between these two memory devices 150 and 152 is established (“Bridged MQTT broker”), which supports data exchange based on the MQTT protocol.

The arrow P8 indicates a communication connection between the data transmission device 96 (the ready kit) and the memory device 152, which in this case is a cloud-based memory device (so-called “Krones PET cloud”). Preferably, the communication between the data transmission device 96 and the cloud-based memory device (“Syskron cloud”) is based on the MQTT protocol.

Furthermore preferably in the embodiment described herein, a communication connection is established between the detection device 94 (“Bottle identifier”) and the data transmission device 96, which particularly preferably supports and/or is arranged for communication based on the MQTT protocol. Thus, it is possible for the detection device 94 (“Bottle identifier”) to be provided with the transmitted data of each machine or treatment apparatus. Subsequently, the detection device 94 (“Bottle identifier”), at which the bottle is currently located, aggregates the data (from the treatment apparatuses) and writes them to the memory device 152 (“Krones PET cloud”).

A (communication) connection P8, based in particular on the MQTT protocol, between the data transmission device 96 and the memory device 152 (“Krones PET cloud”) preferably enables synchronization of the data. Measures to be derived from this, e.g. the reversal of a bottle, can be instructed by the memory device 152 (“Krones PET cloud”), communicated to the data transmission device 96 and implemented by the machine control.

FIG. 2 shows a schematic diagram of a system 1 according to the invention for treating containers in accordance with a first embodiment. In this context, (mutually) identical reference signs identify identically acting devices or elements.

In contrast to FIG. 1, in the embodiment shown in FIG. 2, a communication device 140 is provided which has a common bus system or common bus for data communication for all treatment apparatuses as well as detection devices. The common bus serves as an integration layer between the memory device 152 (“Krones PET cloud”) and the in particular digitally connected sensor technology (Cyber physical systems, CPS) (of the individual treatment apparatuses).

In the embodiment shown herein, the ID pool IDP and the identifier generating device IDG (ID generator) are located as service repositories within the cloud or the memory device 152. Furthermore, an ID generator application IDA (“ID Generator App”) is provided, which represents a (corresponding) service instance.

In the embodiment shown here, communication no longer takes place via the detour of a data transmission device 96, but sensor values and other data are preferably transmitted directly from the machine or the individual treatment apparatuses to the memory device (cloud). Here, too, MQTT can be used as the protocol. Communication between the memory device 152 (“Krones PET cloud”) and the memory device 150 (“Syskron cloud”) can be achieved via a so-called bridging of the MQTT brokers as a so-called MQTT bridge.

The reference sign P20 indicates an arrow illustrating a data exchange between the printing device 50 (“ID printer unit”) and the ID generator application IDA, in which the printing device 50 makes a request to the ID generator application IDA to transmit an identifier (“Request: ID”). The arrow P22 illustrates a transmission of an identifier from the ID generator application IDA to the printing device 50 (“Response: ID”).

Arrows P24, P26 respectively indicate a data transmission from a treatment apparatus, in this case inspection apparatus 60 and a control apparatus (“Checkmat”), in which an update of the status of the bottle 10 is transmitted to the integration layer 140. Thus, the inspection apparatus 60 transmits the updated status of the container that the bottle is “OK” and the preform is inflated (transmitting the message: “Read, update status=bottle OK, preform inflated”). The control apparatus 90 transmits to the integration layer 140 the now current state of the container that the bottle is in a filled and sealed state (transmission of the message: “Read, update status=bottle OK, filled and sealed”).

Finally, the arrow P29 indicates a data communication between the labeling apparatus 120 and the integration layer 140, in which the labeling apparatus transmits a request to the integration layer 140 asking for transmission of the ID and/or data values (“Request: ID, data”). Finally, P30 indicates a transmission of the response message (“Response: ID, data”), in which data values associated with an identifier are transmitted to the labeling apparatus.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 system
10 container
20 transport device
42 identifier
50 printing device
70 filling device
80 closing device
85 checkmat
90 checkmat
94 detection device
96 data transmission device, ready kit
110 drying device
120 labeling device
130 packaging device
140 communication device, data communication bus
150 memory device
152 memory device
IDG identifier generating device, ID generator
IDP ID pool
P1-P39 arrows

1-13. (canceled)

14: A method for operating a system for treating a plurality of containers having the steps:
providing at least one container which has an ID by which the container can be uniquely identified,
wherein an identifier can be assigned to the ID, which identifier is stored in at least one memory device which is cloud-based and/or at least temporarily connected or connectable via a public network to the system for data communication;
treating the container with at least one treatment apparatus of the system,
transporting the container at least temporarily in the treatment apparatus with at least one transport device;
collecting at least one data value with respect to the container and/or with respect to at least one treatment step of the container; and
providing the at least one data value for transmission and/or storage in the memory device;
producing an assignment between the data value and the respective identifier of the container.

15: The method according to claim 14,
wherein
an identifier generating device of the system provides the identifier which is suitable and intended for a unique identification of a container.

16: The method according to claim 14,
wherein
the containers are provided with the ID during their production and/or temporal before and/or during a forming process from a plastic preform to the plastic container.

17: The method according to claim 14,
wherein
the ID is detected at least once before the container is discharged from the treatment apparatus.

18: The method according to claim 14,
wherein
the data value is selected from a group containing information relating to the container, to a measured value, to a treatment parameter, to a process data value, to a time stamp, to a production date, to a product for the container, to the treatment apparatus, to machine data, to an outer packaging, to the transport device, to a distribution modality, to a distribution location and similar.

19: The method according to claim 14,
wherein
at least two data values of different kind are collected, which are assignable to the same ID and/or the same identifier and which are collected by at least two different treatment apparatuses.

20: A system for treating a plurality of containers, having at least one treatment apparatus which is configured for carrying out at least one treatment step on the containers, wherein the treatment apparatus has at least one data collection device which is configured for data collection of at least one data value with respect to the container and/or with respect to at least one treatment step, wherein the system has at least one detection device for detecting an ID of the containers, by means of which the containers can each be uniquely identified,
wherein
the system has a communication device which is configured to at least temporarily establish a communication connection with at least one memory device which is cloud-based and/or is connected or connectable to the system at least temporarily via a public network for data communication, wherein an identifier which can be uniquely assigned to the ID is stored and/or can be stored in the memory device, wherein the treatment apparatus is configured, suitable and intended to provide the at least one data value to the communication device for transmission to and/or for storage in the memory device.

21: The system according to claim 20,
wherein
a data transmission device is provided which collects the data values of at least two treatment apparatuses to be transmitted to the memory device before they are transmitted to the memory device.

22: The system according to claim 20,
wherein
the communication device has an integration layer, wherein a communication connection between the treatment apparatus and the memory device can be established exclusively via the integration layer.

23: The system according to claim 20,
wherein
the communication device has at least one wired communication bus for transmitting data, via which communication of the treatment apparatus with the memory device takes place.

24: The system according to claim 20,
wherein
the treatment apparatus is selected from a group comprising a heating apparatus for heating a preform, a forming apparatus for forming a plastic preform into a plastic bottle, a sterilizing apparatus for sterilizing a container, a production apparatus for producing a glass bottle, a filling apparatus for filling a container with a product, an inspection device for inspecting a plastic preform or bottle, a labeling apparatus for labeling a container, a sealing apparatus for sealing a container, a control device, a packaging device, a direct printing device for printing a container, an assembling apparatus for assembling a plurality of containers into an assembly, a destroying apparatus for destroying the container, and similar.

25: The system according to claim 20,
wherein
the treatment apparatus is configured to receive data relating to a container to be treated, transmitted by the communication device from the memory device, and to make a change in at least one setting and/or size and/or at least one process parameter relating to the treatment of the container to be treated.

26: A system of a system for treating a plurality of containers as claimed in claim 20, and at least one public network-accessible and/or cloud-based storage device.
